(19) United States
(12) Patent Application Publication
(10) Pub. No.: US 2023/0166444 A1
(43) Pub. Date: Jun. 1, 2023

(54) METHOD FOR PRODUCING THREE DIMENSIONAL SHAPED OBJECT AND THREE DIMENSIONAL SHAPING DEVICE

(71) Applicant: SEIKO EPSON CORPORATION, Tokyo (JP)

(72) Inventor: Satoshi YAMAZAKI, MATSUMOTO-SHI (JP)

(21) Appl. No.: 18/059,556

(22) Filed: Nov. 29, 2022

(30) Foreign Application Priority Data
Nov. 30, 2021 (JP) 2021-194120

(51) Int. Cl. B29C 64/118; B33Y 10/00; B33Y 30/00; B29C 64/209

(52) U.S. Cl. CPC B29C 64/118; B33Y 10/00; B33Y 30/00; B29C 64/209; B29K 2055/02

(57) ABSTRACT

A method for producing a three dimensional shaped object includes a first step of receiving selection of a shaping mode of a three dimensional shaped object, a second step of plasticizing at least a portion of a material to form a plasticized material using a plasticizing section that includes a rotating flat screw and a barrel, the flat screw having a groove forming surface in which a groove is formed, the barrel having an opposing surface facing the groove forming surface and in which is formed a communication hole communicating with a nozzle, and a third step of ejecting the plasticized material from the nozzle toward a stage. In the second step, the plasticizing section is controlled in accordance with the shaping mode received in the first step.

The present application is based on, and claims priority from JP Application Serial Number 2021-194120, filed Nov. 30, 2021, the disclosure of which is hereby incorporated by reference herein in its entirety.

### BACKGROUND

### 1. Technical Field

The present disclosure relates to a method for producing a three dimensional shaped object and a three dimensional shaping device.

### 2. Related Art

Regarding a three dimensional shaping device, JP-A-2018-187777 discloses that a material is plasticized and converted into a molten material by a plasticizing section having a flat screw, and the molten material is ejected to shape a three dimensional shaped object.

In the related art, in order to obtain a three dimensional shaped object having desired characteristics such as precision, a user finely adjusts the control data of the plasticizing section described above by himself and repeats trial productions. Therefore, there has been a demand for technology capable of shaping a three dimensional shaped object having desired characteristics by a simple method.

### SUMMARY

According to a first aspect of the present disclosure, there is provided a method for producing a three dimensional shaped object. The method for producing a three dimensional shaped object includes a first step of receiving selection of a shaping mode of a three dimensional shaped object, a second step of plasticizing at least a portion of a material to form a plasticized material using a plasticizing section that includes a rotating flat screw and a barrel, the flat screw having a groove forming surface in which a groove is formed, the barrel having an opposing surface facing the groove forming surface and in which is formed a communication hole communicating with a nozzle, and a third step of ejecting the plasticized material from the nozzle toward a stage. In the second step, the plasticizing section is controlled in accordance with the shaping mode received in the first step.

According to a second aspect of the present disclosure, a three dimensional shaping device is provided. The three dimensional shaping device includes a nozzle configured to eject plasticized material toward a stage, a plasticizing section configured to plasticize at least a portion of a material to form a plasticized material, the plasticizing section including a rotating flat screw and a barrel, the flat screw having a groove forming surface in which a groove is formed, the barrel having an opposing surface facing the groove forming surface and in which is formed a communication hole communicating with the nozzle, and a controller configured to control the plasticizing section in accordance with a selected shaping mode to shape a three dimensional shaped object.

### BRIEF DESCRIPTION OF THE DRAWINGS

FIG. 1 is an explanatory view showing a schematic configuration of a three dimensional shaping system.

FIG. 2 is a perspective view showing a schematic configuration of a flat screw.

FIG. 3 is a plan view showing a schematic configuration of a barrel.

FIG. 4 is an explanatory view schematically showing how a three dimensional shaped object is shaped.

FIG. 5 is a flowchart of a shaping data generation process.

FIG. 6 is a diagram showing examples of shaping modes.

FIG. 7 is a diagram showing an example of layer data.

FIG. 8 is a flowchart of the three dimensional shaping process.

### DESCRIPTION OF EMBODIMENTS

### A. First Embodiment

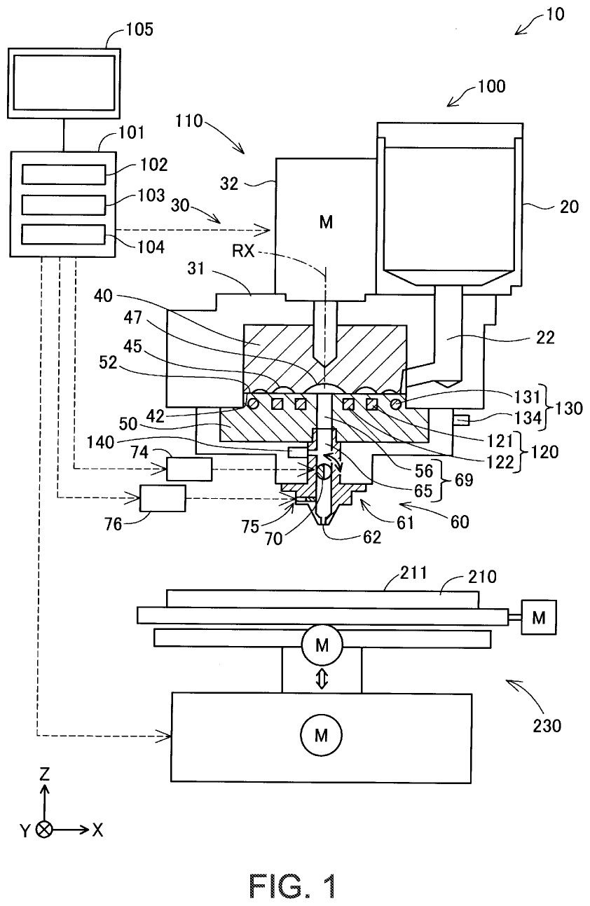

FIG. 1 is an explanatory diagram showing a schematic configuration of a three dimensional shaping system 10 according to the first embodiment. In FIG. 1, arrows indicating X, Y, and Z directions orthogonal to each other are shown. The X direction and the Y direction are directions parallel to a horizontal plane, and the Z direction is a direction along a vertically upward direction. The arrows indicating the X, Y, and Z directions are appropriately illustrated in other drawings so that the illustrated directions correspond to those in FIG. 1. In the following description, when a direction is specified, a direction indicated by an arrow in each drawing is referred to as “+” and an opposite direction is referred to as “−”, and positive and negative signs are used in combination for direction notation. Hereinafter, the +Z direction is also referred to as “upper”, and the −Z direction is also referred to as “lower”.

The three dimensional shaping system 10 includes a three dimensional shaping device 100 and a controller 101 that controls the three dimensional shaping device 100. The three dimensional shaping device 100 includes a shaping section 110 that generates and ejects a plasticized material, a shaping stage 210 that serves as a base of the three dimensional shaped object, and a movement mechanism 230 that controls an ejection position of the plasticized material. The three dimensional shaping device 100 may be housed in a chamber (not shown).

Under the control of the controller 101, the shaping section 110 melts a material, which was in a solid state, and ejects a plasticized material in a paste state onto the stage 210. The shaping section 110 includes a material supply section 20 that is a supply source of a material before being converted into a plasticized material, a plasticizing section 30 that converts the material into the plasticized material, and a ejection section 60 that ejects the plasticized material.

The material supply section 20 supplies a material for generating a plasticized material to the plasticizing section 30. The material supply section 20 is constituted by, for example, a hopper that accommodates the material. The material supply section 20 has a discharge port in the lower part. The discharge port is connected to the plasticizing section 30 via a supply path 22. The material is introduced into the material supply section 20 in the form of pellets, powder, or the like. In the present embodiment, a pellet-shaped ABS resin material is used.

The plasticizing section 30 includes a screw case 31, a drive motor 32, a flat screw 40, a barrel 50, a heating section 120, and a cooling section 130. The plasticizing section 30 plasticizes at least a part of the material supplied from the material supply section 20, generates a plasticized material in a paste state having fluidity, and supplies the plasticized material to the ejection section 60. “Plasticization” is a concept including melting, and is a change from a solid to a state having fluidity. Specifically, in the case of a material in which glass transition occurs, plasticization means that the temperature of the material is set to be equal to or higher than the glass transition point. In the case of a material that does not undergo glass transition, plasticization refers to raising the temperature of the material above its melting point.

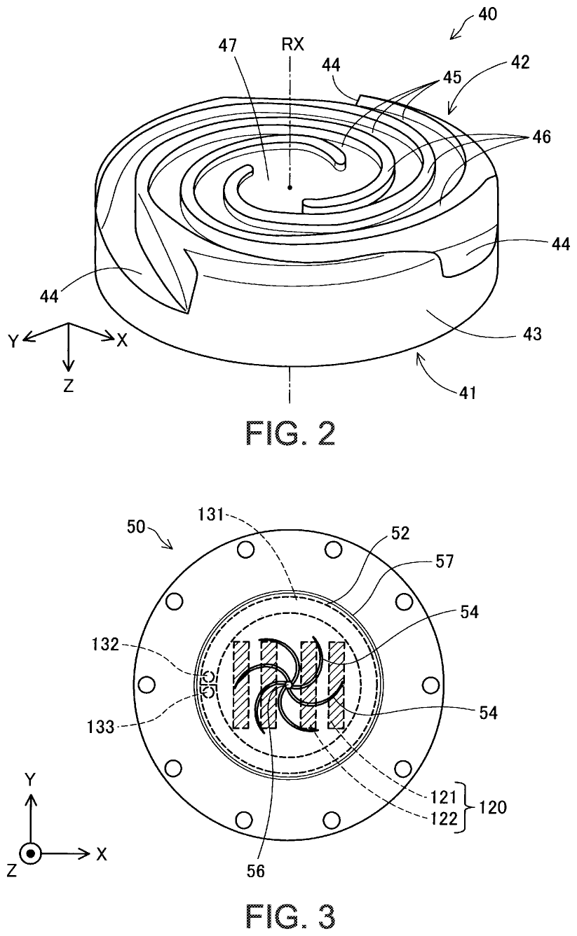

FIG. 2 is a perspective view showing a schematic configuration of the flat screw 40. The flat screw 40 has a substantially cylindrical shape with a height in its axial direction, which is a direction along a central axis RX thereof, smaller than its diameter. The flat screw 40 is disposed such that the central axis RX, which is its center of rotation, is parallel to the Z direction. The flat screw 40 may also be referred to as a scroll or a rotor.

As shown in FIG. 1, the flat screw 40 is housed in the screw case 31. As shown in FIGS. 1 and 2, the flat screw 40 has a groove forming surface 42 in which grooves 45 are formed. In this embodiment, the groove forming surface 42 is constituted by the lower surface of the flat screw 40. An upper surface side of the flat screw 40 is connected to the drive motor 32, and the flat screw 40 is rotated in the screw case 31 by a rotational driving force generated by the drive motor 32. The drive motor 32 is driven under the control of the controller 101. The flat screw 40 may be driven by the drive motor 32 via a reduction gear.

As shown in FIG. 2, vortex-shaped grooves 45 are formed in the groove forming surface 42. The supply path 22 of the material supply section 20 described above communicates with the grooves 45 from the side surface of the flat screw 40. The grooves 45 are contiguous with a material inlet 44 formed on the side surface of the flat screw 40. The material inlet 44 is a portion that receives the material supplied via the supply path 22 of the material supply section 20. As shown in FIG. 3, in the present embodiment, three grooves 45 are formed while being separated from each other by a ridge section 46. The number of grooves 45 is not limited to three, and may be one or two or more. The grooves 45 are not limited to a vortex shape, but may be a spiral shape or an involute curve shape, or may be a shape extending so as to draw an arc from the central section 47 toward the outer periphery.

FIG. 3 is a plan view showing a schematic configuration of the barrel 50. As shown in FIG. 1, in this embodiment, the barrel 50 is disposed below the flat screw 40. As shown in FIGS. 1 and 3, the barrel 50 has an opposing surface 52 that faces the groove forming surface 42 of the flat screw 40. In this embodiment, the opposing surface 52 is constituted by an upper surface of the barrel 50. In addition, the opposing surface 52 and the groove forming surface 42 face each other in the Z direction, and a space is formed between the opposing surface 52 and the grooves 45 of the groove forming surface 42. The barrel 50 is provided with a communication hole 56 at the central axis RX of the flat screw 40, the communication hole 56 communicating with a nozzle 61 of the ejection section 60 (to be described later).

As shown in FIG. 3, a plurality of guide grooves 54 are formed around the communication hole 56 in the opposing surface 52. Each of the guide grooves 54 has one end connected to the communication hole 56 and extends in a vortex shape from the communication hole 56 toward the outer periphery of the opposing surface 52. Each guide groove 54 has the function of guiding the plasticized material to the communication hole 56. Note that one end of the guide grooves 54 may not be connected to the communication hole 56. Also, the barrel 50 may not be formed with the guide groove 54.

The heating section 120 shown in FIGS. 1 and 3 heats the material supplied between the groove forming surface 42 and the opposing surface 52. The heating section 120 in the present embodiment includes a first heating section 121 and a second heating section 122.

In FIG. 3, the positions of the first heating section 121 and the second heating section 122 as viewed along the Z direction are indicated by broken lines and hatching. The second heating section 122 is disposed at a position closer to the communication hole 56 than the first heating section 121 when viewed along the Z-direction. More specifically, in the present embodiment, each of the first heating section 121 and the second heating section 122 is configured by a pair of rod-shaped heaters embedded in the barrel 50. The pairs of rod-shaped heaters constituting the first heating section 121 and the second heating section 122 are disposed such that the longitudinal direction thereof is along the Y direction and also the communication hole 56 is interposed therebetween in the X direction. The first heating section 121 is configured by the two rod-shaped heaters that are closer to the communication hole 56 as viewed along the Z direction, and the second heating section 122 is configured by the two rod-shaped heaters that are farther from the communication hole 56 as viewed along the Z direction. The first heating section 121 and the second heating section 122 are configured to be individually controllable by the controller 101. In another embodiment, the first heating section 121 and the second heating section 122 may not be configured by rod-shaped heaters, and may be configured by, for example, an annular heater disposed along the opposing surface 52.

The cooling section 130 cools the plasticizing section 30. As shown in FIG. 1, the cooling section 130 in the present embodiment includes a refrigerant flow path 131 and a refrigerant circulation device 134.

As shown in FIG. 3, the refrigerant flow path 131 has an inlet section 132 and an outlet section 133. In FIG. 3, positions of the refrigerant flow path 131, the inlet section 132, and the outlet section 133 as viewed along the Z direction are indicated by broken lines. The coolant introduced into the refrigerant flow path 131 via the inlet section 132 flows in refrigerant flow path 131 toward the outlet section 133, and the coolant is discharged from the refrigerant flow path 131 via the outlet section 133. The refrigerant flow path 131 in the present embodiment is formed inside the barrel 50. In the present embodiment, the refrigerant flow path 131 is formed in a substantially annular shape along the circumferential direction of the opposing surface 52 so as to surround the heating section 120 as viewed along the Z direction. More specifically, the refrigerant flow path 131 in the present embodiment is disposed between the second heating section 122 and the outer edge 57 of the opposing surface 52 as viewed along the Z-direction. The refrigerant circulation device 134 shown in FIG. 1 is connected to the inlet section 132 and the outlet section 133. The refrigerant circulation device 134 is configured by a chiller that maintains the temperature of the refrigerant flowing through the refrigerant flow path 131 by air cooling, water cooling, or the like while circulating the refrigerant through the refrigerant flow path 131. The refrigerant circulation device 134 is controlled by the controller 101. Note that in another embodiment, the refrigerant flow path 131, the inlet section 132, and the outlet section 133 may be formed inside the screw case 31, and the refrigerant flow path 131 may be formed inside the screw case 31 along the outer periphery of the flat screw 40.

The material supplied into the grooves 45 of the flat screw 40 flows along the grooves 45 by the rotation of the flat screw 40 while being melted in the grooves 45, and is guided to the central section 47 of the flat screw 40 as a plasticized material. The plasticized material in a paste state that developed fluidity and flowed into the central section 47 is supplied to the nozzle 61 via the communication hole 56. Note that not all types of substances constituting the plasticized material need be melted, and it is sufficient that least some types of substances among the substances constituting the plasticized material are melted in order to convert the plasticized material as a whole into a state having fluidity.

The controller 101 can adjust the amount of the plasticized material supplied to the nozzle 61 via the communication hole 56 by adjusting the screw rotation speed, which indicates the number of rotations of the flat screw 40 per unit time, and the set temperatures of the heating section 120 and the cooling section 130. This makes it possible to adjust the ejection amount of the plasticized material ejected from the nozzle 61. For example, by increasing the screw rotation speed, the controller 101 can guide a larger amount of material to the central section 47 per unit time, and thus can increase the ejection amount. In addition, since the controller 101 can further promote plasticization of the material in the plasticizing section 30 by increasing the set temperature of the heating section 120 or the set temperature of the cooling section 130 to increase the temperature of the plasticizing section 30, the ejection amount can be increased.

In addition, in the present embodiment, when the material is plasticized by the plasticizing section 30 to generate the plasticized material, the controller 101 controls the first heating section 121, the second heating section 122, and the cooling section 130 described above to generate the temperature gradient of the plasticizing section 30. The temperature gradient of the plasticizing section 30 refers to a temperature gradient in the plasticizing section 30 that increases from the outer edge of the opposing surface 52 toward the communication hole 56 as viewed along the Z direction. By generating the temperature gradient in the plasticizing section 30, the material supplied between the groove forming surface 42 and the opposing surface 52 is heated to higher temperatures with greater proximity to the central section 47. Therefore, the fluidity of the material located in the vicinity of the material inlet 44 can be easily kept lower than the fluidity of the material located in the vicinity of the central section 47. This makes it easy to obtain a conveying force for conveying the material from the material inlet 44 toward the central section 47, and thus it is possible to stabilize the delivery amount of plasticized material delivered from the plasticizing section 30 toward the nozzle 61. In addition, for example, by increasing the temperature gradient of the plasticizing section 30 by further increasing the set temperature of the second heating section 122, it is possible to further increase the conveying force of the material in the plasticizing section 30.

The ejection section 60 includes the nozzle 61 that ejects the plasticized material, a supply flow path 65 provided between the flat screw 40 and the nozzle opening 62, an ejection control section 70 that opens and closes the supply flow path 65, and a suction and discharge section 75 that suctions and temporarily stores the plasticized material. The nozzle 61 is connected to the communication hole 56 of the barrel 50 through the supply flow path 65. The nozzle 61 ejects the plasticized material that was generated in the plasticizing section 30 from a nozzle opening 62 in the tip of the nozzle 61 toward the stage 210. A heater that suppresses a decrease in temperature of the plasticized material ejected onto the stage 210 may be disposed around the nozzle 61.

The ejection control section 70 is provided in the supply flow path 65 communicating with the nozzle opening 62, and changes the opening degree of the supply flow path 65 by rotating in the supply flow path 65. In the present embodiment, the ejection control section 70 is constituted by a butterfly valve. The ejection control section 70 is driven by the first driving section 74 under the control of the controller 101. The first driving section 74 is configured by, for example, a stepping motor. The controller 101 switches between a state in which the opening degree of the supply flow path 65 is 0 and a state in which the opening degree is larger than 0 by using the first driving section 74 to control the rotation angle of the butterfly valve. Accordingly, the controller 101 controls ON/OFF of ejection of the plasticized material through the nozzle 61.

The suction and discharge section 75 is connected between the ejection control section 70 and the nozzle opening 62 in the supply flow path 65. The suction and discharge section 75 performs a suction operation of sucking the plasticized material in the supply flow path 65 and a discharge operation of pushing out the sucked plasticized material toward the nozzle opening 62. In this embodiment, the suction and discharge section 75 is constituted by a plunger. The suction and discharge section 75 retracts the plunger in a direction away from the supply flow path 65 in the above-described suction operation, and advances the plunger in a direction toward the supply flow path 65 in the discharge operation. The suction and discharge section 75 is driven by the second driving section 76 under the control of the controller 101. The second driving section 76 is configured by, for example, a stepping motor, a rack and pinion mechanism that converts rotational force of the stepping motor into translational motion of a plunger, or the like.

In the present embodiment, the controller 101 executes the suction operation by the suction and discharge section 75 when feed of the plasticized material from the nozzle 61 is stopped, thereby suppressing the phenomenon of tailing, in which the plasticized material drips like a thread from the nozzle opening 62. In this case, the controller 101 can more effectively suppress the tailing phenomenon by executing the suction operation after the ejection control section 70 sets the opening degree of the supply flow path 65 to 0. In addition, the suction and discharge section 75 performs a discharge operation by the suction and discharge section 75 when feed of the plasticized material from the nozzle 61 is started or restarted, thereby improving the responsiveness of feed of the plasticized material from the nozzle 61. In this case, the controller 101 executes the suction operation before the ejection control section 70 makes the opening degree of the supply flow path 65 larger than 0, so that the responsiveness of the delivery of the plasticized material can be further enhanced. Note that in another embodiment, for example, the controller 101 may stop feed of the plasticized material and start or restart feed of the plasticized material by controlling one of the ejection control section 70 or the suction and discharge section 75.

Hereinafter, the flow path provided in the three dimensional shaping device 100, through which the plasticized material flows may be collectively referred to as a flow path 69. In the present embodiment, the flow path 69 is constituted by the communication hole 56 and the supply flow path 65 described above.

In the present embodiment, the flow path 69 is provided with a pressure sensor 140 that detects the pressure in the flow path 69. The pressure sensor 140 in the present embodiment is configured by a diaphragm-type pressure sensor. The pressure sensor 140 is connected upstream of the ejection control section 70 in the supply flow path 65, and detects pressure of the plasticized material in the supply flow path 65 upstream of the ejection control section 70. In another embodiment, the pressure sensor 140 may be configured by, for example, a piezoelectric pressure sensor or the like. For example, the pressure sensor 140 may be connected to the communication hole 56 to detect the pressure in the communication hole 56.

The stage 210 is disposed at a position facing the nozzle opening 62 of the nozzle 61. In the first embodiment, the shaping surface 211 of the stage 210 facing the nozzle opening 62 of the nozzle 61 is arranged to be parallel to the X and Y directions, that is, the horizontal direction. In a three dimensional shaping process (to be described later), the three dimensional shaping device 100 shapes a three dimensional shaped object by ejecting a plasticized material from the ejection section 60 toward the shaping surface 211 of the stage 210 and laminating it in layers. The stage 210 may be provided with a heater for suppressing rapid cooling of the plasticized material ejected onto the stage 210.

The movement mechanism 230 changes the relative position between the stage 210 and the nozzle 61. In this embodiment, the position of the nozzle 61 is fixed, and the movement mechanism 230 moves the stage 210. The movement mechanism 230 is configured by a three axis positioner that moves the stage 210 in three axis directions of X, Y, and Z directions by driving forces of three motors. The movement mechanism 230 changes the relative positional relationship between the nozzle 61 and the stage 210 under the control of the controller 101. In this specification, unless otherwise specified, the movement of the nozzle 61 means that the nozzle 61 or the ejection section 60 is relatively moved with respect to the stage 210. Hereinafter, the relative moving speed of the nozzle 61 with respect to the stage 210 may be simply referred to as the moving speed of the nozzle 61.

Note that in another embodiment, instead of the configuration in which the stage 210 is moved by the movement mechanism 230, a configuration may be employed in which the position of the stage 210 is fixed and the movement mechanism 230 moves the nozzle 61 with respect to the stage 210. In addition, a configuration may be employed in which the stage 210 is moved in the Z direction by the movement mechanism 230 and the nozzle 61 is moved in the X and Y directions, or in which the stage 210 is moved in the X and Y directions by the movement mechanism 230 and the nozzle 61 is moved in the Z direction. Even in these configurations, the relative positional relationship between the nozzle 61 and the stage 210 can be changed.

The controller 101 is a control device that controls the operation of the entire three dimensional shaping device 100. The controller 101 is configured by a computer including one or a plurality of processors, a storage device, and an input/output interface that performs input and output of signals with the outside. A display section 105 configured by a liquid crystal display, an organic EL display, or the like is connected to the controller 101. The controller 101 exhibits the functions of a reception section 102, a shaping data generation section 103, and a shaping processing section 104 by causing the processor to execute programs and commands read from the storage device. Instead of being configured by a computer, the controller 101 may be realized by a configuration in which a plurality of circuits are combined for realizing at least a part of each function. The controller 101 is also referred to as an information processing apparatus.

The reception section 102 receives selection of a shaping mode of a three dimensional shaped object from a user through an input device such as a mouse or a keyboard (not shown). The shaping mode includes at least one of a mode related to precision of the three dimensional shaped object and a mode relating to shaping time of the three dimensional shaped object. Details of the shaping mode will be described later.

The shaping data generation section 103 generates shaping data for shaping a three dimensional shaped object based on the shaping mode received by the reception section 102. The shaping data includes path information indicating movement paths of the ejection section 60, ejection amount information indicating an ejection amount of the plasticized material in each movement path, and control information for controlling the ejection section 60 and the plasticizing section 30. The movement path of the ejection section 60 is a path in which the nozzle 61 moves along the shaping surface 211 of the stage 210 while discharging the plasticized material. In the present embodiment, the shaping data includes outer shell shaping data and internal shaping data. Each of the outer shell shaping data and the internal shaping data includes the ejection amount information and the control information described above. Details of the outer shell shaping data and the internal shaping data will be described later.

The path information includes a plurality of partial paths. Each partial path is a linear path represented by a start point and an end point. Ejection amount information is individually associated with each partial path. In the present embodiment, the ejection amount represented by the ejection amount information is the amount of plasticized material ejected per unit time in a partial path. In another embodiment, the total amount of plasticized material ejected in the entire partial path may be associated with each partial path as the ejection amount information.

The shaping processing section 104 controls the shaping section 110, including the plasticizing section 30 and the ejection section 60, and the movement mechanism 230 based on the shaping data generated by the shaping data generation section 103 to shape a three dimensional shaped object on the stage 210. When shaping a three dimensional shaped object, the shaping processing section 104 causes the ejection section 60 to move while ejecting the plasticized material based on the path information and the ejection amount information included in the shaping data, and controls the plasticizing section 30 based on the control information.

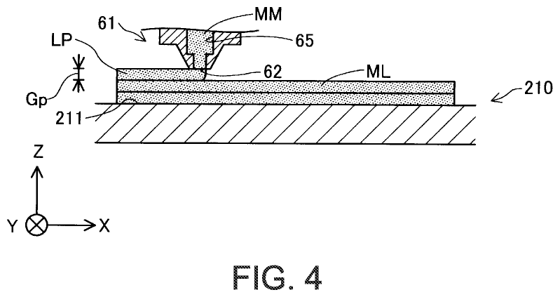

FIG. 4 is an explanatory diagram schematically showing how a three dimensional shaped object is shaped in the three dimensional shaping device 100. In the plasticizing section 30 of the three dimensional shaping device 100, as described above, the material in a solid state supplied to the grooves 45 of the rotating flat screw 40 is melted to generate plasticized material MM. The controller 101 causes the nozzle 61 to eject plasticized material MM while changing the position of the nozzle 61 with respect to the stage 210 in a direction along the shaping surface 211 of the stage 210 while maintaining the distance between the shaping surface 211 of the stage 210 and the nozzle 61. The plasticized material MM ejected from the nozzle 61 is continuously deposited in the moving direction of the nozzle 61. By this type of scanning by the nozzle 61, a linear portion LP, which is a shaping portion linearly extending along a scanning path of the nozzle 61, is shaped.

The controller 101 forms a layer ML by repeating the scanning by the nozzle 61 described above. After forming one layer ML, the controller 101 moves the position of the nozzle 61 with respect to the stage 210 in the Z direction. Then, the three dimensional shaped object is shaped by further stacking layers ML on the layers ML formed so far.

When the layers of the plasticized material are laminated, the controller 101 causes the plasticized material to be ejected from the nozzle 61 while maintaining the distance between the nozzle 61 and the ejection target. The ejection target is the shaping surface 211 when the plasticized material is ejected onto the shaping surface 211, and is the upper surface of already ejected plasticized material when the plasticized material is ejected onto already ejected plasticized material. The distance between the nozzle 61 and the ejection target may be referred to as a gap Gp.

The width of the above-described linear portion LP may be referred to as a line width, and the height thereof may be referred to as a lamination pitch. In the example of FIG. 4, the line width corresponds to the dimension of the linear portion LP in the Y direction, and the lamination pitch corresponds to the dimension of the linear portion LP in the Z direction. The line width and the lamination pitch are determined by the size of the gap Gp described above and the amount of the plasticized material ejected from the nozzle 61 per unit movement amount. For example, when the gap Gp is small, the plasticized material ejected from the nozzle 61 is pressed against the ejection target by the nozzle 61 more than when the gap Gp is large, and thus the lamination pitch is small and the line width is large. The amount of plasticized material ejected from the nozzle 61 per unit movement amount is determined by, for example, the moving speed of the nozzle 61 and the amount of the plasticized material ejected from the nozzle 61 per unit time. The amount of the plasticized material ejected from the nozzle 61 per unit time is determined by, for example, the diameter of the nozzle opening 62, the flow rate of plasticized material flowing in the flow path 69, and the like.

In the present embodiment, when shaping a three dimensional shaped object, the controller 101 changes the screw rotation speed according to the moving speed of the nozzle 61. Accordingly, for example, even if the moving speed of the nozzle 61 moving while discharging the plasticized material is changed in the middle of the movement, it is possible to realize control such that the line width of the ejected plasticized material is maintained substantially constant.

In addition, in the present embodiment, when the nozzle 61 changes the direction by 60° or more while discharging plasticized material, the controller 101 decreases the moving speed of the nozzle 61 compared to a normal speed when the nozzle 61 moves straight or moves while changing the direction by less than 60°. More specifically, the controller 101 gradually decreases the moving speed of the nozzle 61 until the nozzle 61 reaches the direction change point, and gradually increases the moving speed of the nozzle 61 while the nozzle 61 separates from the direction change point to return the moving speed to the normal speed. Also, the controller 101 decreases the screw rotation speed in accordance with a decrease in the moving speed of the nozzle 61, and increases the screw rotation speed in accordance with an increase in the moving speed of the nozzle 61. Note that the controller 101 makes the moving speed of the nozzle 61 slower than the normal speed, for example, also when stopping movement of the nozzle 61 and ejection of the plasticized material, or when starting or restarting movement of the nozzle 61 and ejection of the plasticized material.

In the present embodiment, when shaping a three dimensional shaped object, the controller 101 performs feedback control on the plasticizing section 30 such that the detection value of the pressure sensor 140 described above falls within a predetermined allowable range. More specifically, the controller 101 controls the screw rotation speed so that the detection value of the pressure sensor 140 falls within an allowable range. More specifically, the controller 101 adjusts the screw rotation speed so that the detection value falls within the allowable range by decreasing the screw rotation speed when the detection value of the pressure sensor 140 exceeds an upper limit value while plasticized material is being discharged and increasing the screw rotation speed when the detection value falls below a lower limit value while plasticized material is being discharged. The upper limit value and the lower limit value are determined, for example, as values obtained by multiplying, by a certain ratio, the predicted value of the pressure when a certain ejection amount of plasticized material is ejected. For example, the upper limit value is set to a value of 105% of the predicted value of the pressure, and the lower limit value is similarly set to a value of 95% of the predicted value of the pressure. In this case, as the ratio for determining the upper limit value and the lower limit value approaches 100%, the allowable range of pressure becomes narrower.

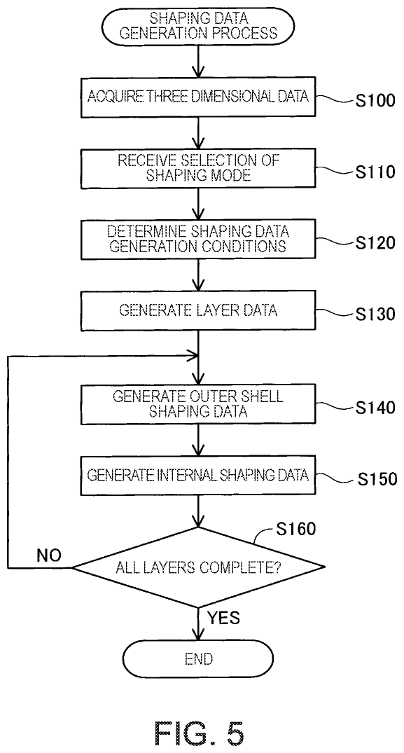

FIG. 5 is a flowchart of a shaping data generation process executed by the controller 101. The shaping data generation process is a process prior to shaping a three dimensional shaped object, for generating shaping data used for shaping the three dimensional shaped object.

As shown in FIG. 5, in step S100, the controller 101 acquires three dimensional data representing the shape of the three dimensional shaped object. For example, the controller 101 acquires three dimensional data such as three dimensional CAD data from outside through a network or from a recording medium.

In step S110, the reception section 102 receives selection of the shaping mode from the user. For example, the controller 101 displays the names of the respective shaping modes on the display section 105, and the user selects a desired shaping mode from among them using an input device such as a mouse or a keyboard. Step S110 is also referred to as a first step in a method for producing a three dimensional shaped object.

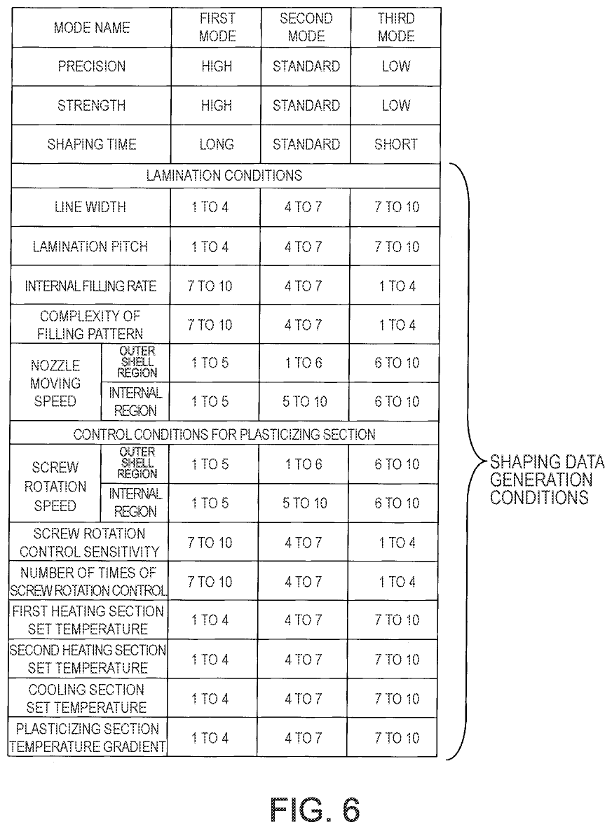

FIG. 6 is a diagram showing examples of shaping modes. In the present embodiment, a first mode, a second mode, and a third mode are prepared as modes relating to the precision of the three dimensional shaped object or modes relating to the shaping time of the three dimensional shaped object. These modes differ from each other in the precision of the three dimensional shaped object to be shaped and the shaping time until the three dimensional shaped object is completed.

The first mode corresponds to a high-precision mode in which a three dimensional shaped object is shaped with high precision. In the present embodiment, the first mode also corresponds to a low-speed mode in which a three dimensional shaped object is shaped at a low speed. More specifically, as shown in FIG. 6, in the first mode of the present embodiment, the precision of the three dimensional shaped object is higher than in the second mode and in the third mode, and the shaping time of the three dimensional shaped object is longer than in the second mode and in the third mode. Hereinafter, the first mode may be simply referred to as a high-precision mode or a low-speed mode. In the first mode of the present embodiment, the strength of the three dimensional shaped object is higher than in the second mode and in the third mode. Therefore, it can be said that the first mode in the present embodiment is a mode for shaping a three dimensional shaped object with high strength.

The third mode corresponds to a high-speed mode in which a three dimensional shaped object is shaped at high speed. In the present embodiment, the third mode also corresponds to a low-precision mode in which a three dimensional shaped object is formed with low precision. More specifically, as shown in FIG. 6, in the third mode in the present embodiment, the precision of the three dimensional shaped object is lower than in the first mode and in the second mode, and the shaping time of the three dimensional shaped object is shorter than in the first mode and in the second mode. Hereinafter, the third mode may be simply referred to as a high-speed mode or a low-precision mode. In the third mode according to the present embodiment, the strength of the three dimensional shaped object is lower than in the first mode and in the second mode. Therefore, it can also be said that the first mode in the present embodiment is a mode for shaping a three dimensional shaped object with low strength.

The second mode corresponds to a standard mode in which a three dimensional shaped object is formed with standard precision and at a standard speed. In addition, in the second mode of the present embodiment, the three dimensional shaped object is shaped with standard strength.

In step S120 of FIG. 5, the shaping data generation section 103 determines shaping data generation conditions in accordance with the shaping mode received in step S110. As shown in FIG. 6, in order to realize the strength and shaping time corresponding to each shaping mode, various shaping data generation conditions are determined and stored in the storage device of the controller 101. The shaping data generation section 103 refers to the storage device of the controller 101 and sets shaping data generation conditions corresponding to the shaping mode. As shown in FIG. 6, the shaping data generation conditions in the present embodiment include lamination conditions and control conditions of the plasticizing section 30.

Line width, lamination pitch, internal filling rate, complexity of a filling pattern, and moving speed of the nozzle 61 are set as lamination conditions. The screw rotation speed, screw rotation control sensitivity, the number of times of screw rotation control, the set temperature of the first heating section 121, the set temperature of the second heating section 122, the set temperature of the cooling section 130, the temperature gradient of the plasticizing section 30, and the size of the allowable range of the pressure used in the feedback control of the plasticizing section 30 described above are set as control conditions of the plasticizing section 30. The screw rotation control sensitivity represents the sensitivity to change in the screw rotation speed corresponding to change in the moving speed of the nozzle 61 described above. The number of times of screw rotation control represents the number of times of rotation control per unit time of the flat screw 40.

In FIG. 6, in order to facilitate understanding, the shaping data generation conditions are indicated by using indices of ten levels represented by integers of 1 to 10 for each condition such as a line width, a lamination pitch, and complexity of a filling pattern. In each condition, as the numerical value of the index is larger, the numerical value or degree defined by each condition is larger. For example, a larger numerical value of the line width means a thicker line width, a larger numerical value of the lamination pitch means a larger lamination pitch, and a larger numerical value of the complexity of the filling pattern means a more complicated filling pattern. When the numerical values are the same, the numerical values or the like defined by each condition mean the same degree. For example, the line width in the first mode is set to be substantially equal to or smaller than the line width in the second mode. The shaping data generation conditions shown in FIG. 6 are merely examples, and other conditions may be defined, or a part of the conditions shown in FIG. 6 may be omitted.

As shown in FIG. 6, in the first mode in the present embodiment, as compared with the third mode, making the line width thinner, narrowing the lamination pitch, increasing the filling rate, complicating the filling pattern, and slowing the moving speed of the nozzle 61 are set as the lamination conditions. In the first mode, as compared with the third mode, (1) decreasing the screw rotation speed, (2) decreasing the set temperature of the heating section 120, (3) decreasing the set temperature of the cooling section 130, (4) increasing the number of times of screw rotation control, (5) decreasing the temperature gradient of the plasticizing section 30, and (6) increasing the screw rotation control sensitivity are set as the control conditions of the plasticizing section 30.

In the present embodiment, as described above, in when the first mode is selected, the line width is set to be thinner than when the third mode is selected. The screw rotation speed, the set temperature of the first heating section 121, the set temperature of the second heating section 122, the set temperature of the cooling section 130, and the temperature gradient of the plasticizing section 30 are set as the control conditions of the plasticizing section 30 in order to realize this line width. Also, in the present embodiment, when the first mode is selected, the above-described control conditions are set taking the lamination pitch and the moving speed of the nozzle 61 into consideration because the lamination pitch is narrowed and the moving speed of the nozzle 61 is decreased compared to when the third mode is selected.

As shown in FIG. 6, in the present embodiment, the moving speed of the nozzle 61 set as the lamination condition includes the moving speed when shaping the outer shell region of the three dimensional shaped object and the moving speed when shaping the internal region of the three dimensional shaped object. Also, the screw rotation speed set as the control condition of the plasticizing section 30 includes the rotation speed when shaping the outer shell region and the rotation speed when shaping the internal region. The outer shell region is a region adjacent to the inner side of an outer shell represented by layer data (to be described later), and is a region that affects the appearance of the three dimensional shaped object. The internal region is a region inside the outer shell represented by the layer data, and is a region other than the outer shell region in the three dimensional shaped object. The internal region is a region having a larger influence on the strength of the three dimensional shaped object, rather than on the appearance of the three dimensional shaped object.

In the present embodiment, when the first mode is selected, compared to when the third mode is selected, the moving speed when the outer shell region is formed and the moving speed when the internal region is formed are set slower, and both of the screw rotation speed when the outer shell region is formed and the screw rotation speed when the internal region is formed are decreased according to the setting of the moving speed. Also, when the first mode is selected, the moving speed when the internal region is formed is set to similar to or slower than when the second mode is selected and the moving speed when the outer shell region is formed is set to similar to or slower than when the second mode is selected, and also, in accordance with the setting of the moving speed, the screw rotation speed when the internal region is formed is set to similar to or smaller than when the second mode is selected and the screw rotation speed when the external shell region is formed is set to similar to or smaller than when the second mode is selected.

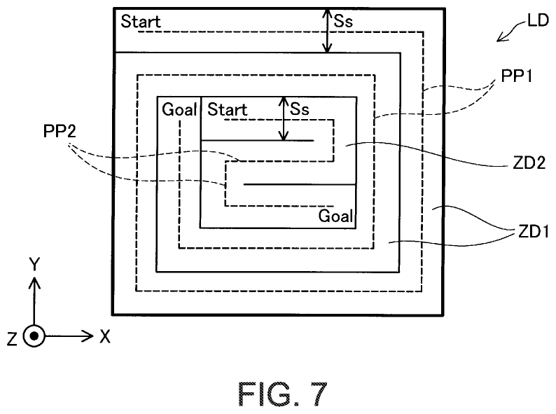

The description will return to FIG. 5. In step S130, the shaping data generation section 103 analyzes the three dimensional data acquired in step S100 and generates layer data obtained by slicing the three dimensional shaped object into a plurality of layers along the XY plane. The slicing interval is set according to the lamination pitch of the shaping data generation conditions determined in step S120. The layer data is data representing an outer shell of the three dimensional shaped object in the XY plane. FIG. 7 is a diagram showing an example of layer data LD. In FIG. 7, a portion corresponding to the outer shell represented by the layer data LD is indicated by a thick line.

In step S140 in FIG. 5, the shaping data generation section 103 generates outer shell shaping data for forming the outer shell region, in accordance with the shaping data generation conditions determined in step S120. The outer shell shaping data includes a path for shaping the outermost periphery along the outer shell of the three dimensional shaped object. The outer shell shaping data may include not only the path information for shaping the outermost periphery of the three dimensional shaped object but also, for example, path information including one circumference to the inside of the outermost periphery. The number of turns in the path information for forming the outer shell region may be arbitrarily set.

FIG. 7 shows an example in which outer shell shaping data ZD1 is configured by the outermost path information and the path information for one inner circumference thereof. The path information includes a plurality of partial paths PP1 for shaping the outer shell region. As described above, each partial path PP1 is a linear path. Each partial path PP1 is associated with an ejection amount as ejection amount information such that the plasticized material deposited on the stage 210 has a line width Ss defined in the shaping data generation conditions.

In step S150 in FIG. 5, the shaping data generation section 103 generates the internal shaping data for forming the internal region in accordance with the shaping data generation conditions determined in step S120.

FIG. 7 shows an example in which the internal shaping data ZD2 is represented inside the outer shell shaping data ZD1. In FIG. 7, the path information filling the internal region represented by the internal shaping data ZD2 is formed to meander by a plurality of partial paths PP2. As described above, each partial path PP2 is a linear path. The path information representing the internal shaping data ZD2 is determined by the internal filling rate and the filling pattern defined in the shaping data generation conditions. The lower the internal filling rate, wider the interval between the adjacent paths, so the paths have more gaps. In addition, a more complicated filling pattern results in paths having more angles in the movement path, that is, in paths having more partial paths. Examples of filling patterns include a grid, a triangle, a concentric circle, and a honeycomb, and a pattern that satisfies the complexity in the shaping data generation conditions is designated for each shaping data generation condition. An ejection amount of an amount that becomes the line width defined in the shaping data generation conditions is associated as ejection amount information with each partial path PP2 included in the internal shaping data ZD2.

Hereinafter, the outer shell shaping data generated in step S140 and the internal shaping data generated in step S150 are collectively referred to simply as “shaping data”.

In the present embodiment, the shaping data includes the above-described control information. The control information includes speed information, which is information for controlling the moving speed of the nozzle 61, and plasticization information, which is information for controlling the plasticizing section 30. The speed information and the plasticization information are designated based on the shaping data generation conditions determined in step S120. The control information may include, for example, information for controlling the ejection control section 70 and the suction and discharge section 75.

In the present embodiment, the plasticizing information of the shaping data includes rotation control frequency information which is information for designating a screw rotation control frequency. The rotation control frequency information includes information on the frequency at which the detection value of the pressure sensor 140 is acquired and information for specifying the allowable range of the pressure described above. The controller 101 generates the rotation control frequency information according to the number of times of screw rotation control included in the control conditions of the plasticizing section 30. For example, when the first mode is selected, the controller 101 generates, as the rotation control frequency information, at least one of information for shortening an interval from one acquisition of the detection value from the pressure sensor 140 to the next acquisition of the detection value and information for narrowing an allowable range of the pressure, compared when the third mode is selected. Accordingly, when the first mode is selected, the number of times of screw rotation control at the time of shaping a three dimensional shaped object is increased compared to when the third mode is selected. By increasing the number of times of screw rotation control in this manner, it is possible to suppress a rapid change in the screw rotation speed and so it is possible to further stabilize the ejection amount of the plasticized material, and it is possible to improve the precision of the three dimensional shaped object.

In the present embodiment, the plasticization information includes rotation control sensitivity information, which is information for specifying screw rotation control sensitivity. The rotation control sensitivity information is represented by a function that defines the relationship between the moving speed of the nozzle 61 and the screw rotation speed. The controller 101 controls the moving speed of the nozzle 61 and the screw rotation speed in accordance with this function when shaping the three dimensional shaped object, thereby realizing a change in the screw rotation speed in accordance with change in the moving speed of the nozzle 61 described above. The controller 101 designates a different function as the rotation control sensitivity information according to the selected shaping mode. These functions may be functions that changes the overall screw rotation speed in accordance with the moving speed of the nozzle 61, and may be defined as, for example, step functions having portions in which the screw rotation speed does not change in accordance with the moving speed of the nozzle 61.

More specifically, when the first mode is selected, the controller 101 designates, as the rotation control sensitivity information, a function capable of increasing the control sensitivity of the screw rotation speed with respect to the moving speed of the nozzle 61 compared to when the third mode is selected. When the control sensitivity of the screw rotation speed is high, the screw rotation speed changes in accordance with smaller changes in the moving speed of the nozzle 61, compared to when the control sensitivity is low. For example, the function specified when the first mode is selected is defined as a function in which the screw rotation speed changes in more stages with respect to the moving speed of the nozzle 61, compared to the function specified when the third mode is selected. In another embodiment, for example, the function designated when the first mode is selected may be a higher-order function than the function designated when the third mode is selected.

In step S160 in FIG. 5, the shaping data generation section 103 determines whether or not the above-described processing has been completed for all the layer data. If processes have not been completed for all layer data, the shaping data generation section 103 repeats the processing in steps S140 and Step S150 for the next layer. When the shaping data generation has been completed for all the layer data, the shaping data generation section 103 ends the shaping data generation process.

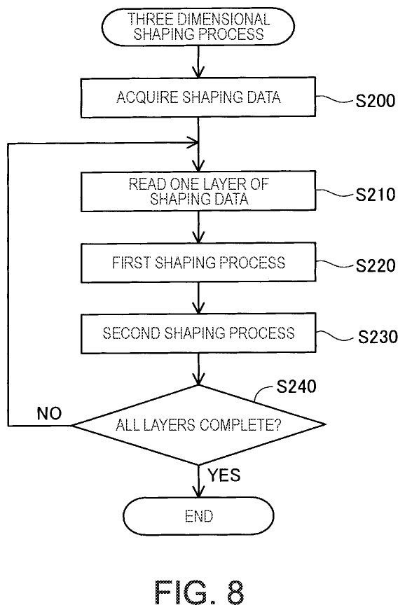

FIG. 8 is a flowchart of a three dimensional shaping process executed by the controller 101. Three dimensional shaping process is a process executed by the controller 101 using the shaping data generated in the shaping data generation process illustrated in FIG. 5. By executing the shaping data generation process shown in FIG. 5 and the three dimensional shaping process shown in FIG. 8, a method for producing a three dimensional shaped object by the three dimensional shaping device 100 is realized.

In step S200, the controller 101 acquires the shaping data generated by the shaping data generation process described above. In step S210, shaping data for one layer of the plurality of layers constituting the three dimensional shaped object is read from the shaping data. In the present embodiment, first, the controller 101 reads the shaping data of the layer located on the lowermost side of the plurality of layers constituting the three dimensional shaped object.

In step S220, the controller 101 executes a first shaping process. The controller 101 forms the outer shell region for the current layer by executing a second step and a third step in the first modeling process. The second step refers to a step of using the plasticizing section 30 to plasticize at least a part of the material to generate a plasticized material. The third step refers to a step of ejecting the plasticized material generated in the second step from the nozzle 61 toward the stage 210 while moving the nozzle 61 relative to the stage 210.

In the present embodiment, in the first shaping process, the controller 101 controls the movement mechanism 230, the plasticizing section 30, and the ejection section 60 in accordance with the partial paths, the ejection amount information, the speed information, and the control information for the plasticizing section 30 included in the outer shell shaping data, in order to form the outer shell region for the current layer. Accordingly, in the second step, control of the plasticizing section 30 according to the shaping mode received in the first step is realized. In the present embodiment, in the second step, the controller 101 individually controls the first heating section 121 and the second heating section 122 of the heating section 120 in accordance with respectively set temperatures included in the outer shell shaping data. Similarly, in the third step, control of the movement mechanism 230 and the ejection section 60 according to the shaping mode is realized.

In step S230, the controller 101 executes the second shaping process. In the second shaping process, the controller 101 forms the internal region for the current layer by executing the second step and the third step in the same manner as in the first shaping process described above. More specifically, in the second shaping process, the controller 101 controls the movement mechanism 230, the plasticizing section 30, and the ejection section 60 in accordance with the partial paths, the ejection amount information, the speed information, and the control information for the plasticizing section 30 included in the internal shaping data, in order to form the internal region for the current layer.

In step S240, the controller 101 determines whether or not shaping has been completed for all layers. If shaping has not been completed for all the layers, the controller 101 returns the process to step S210 and executes the processes of step S210 to step S230 for the next layer, that is, the layer adjacent to the upper side of the current layer. In this case, in step S220, prior to the ejection of the plasticized material from the ejection section 60, the controller 101 controls the movement mechanism 230 to raise the position of the nozzle 61 by one layer. In step S240, in a case where it is determined that shaping has been completed for all the layers, the controller 101 completes the three dimensional shaping process.

According to the first embodiment described above, in the second step, the plasticizing section 30 is controlled in accordance with the shaping mode received in the first step. Therefore, a user can shape a three dimensional shaped object having characteristics corresponding to a shaping mode by merely selecting the shaping mode, without the user himself repeating trial productions and finely adjusting the control data of the plasticizing section 30.

In addition, according to the present embodiment, since the shaping mode includes at least one of a mode related to the shaping precision of the three dimensional shaped object or a mode related to the shaping time of the three dimensional shaped object, the user can easily select a desired shaping mode from the modes prepared according to shaping precision and shaping time.

Further, according to the present embodiment, when the high-precision mode or the low-speed mode is selected, the temperature gradient of the plasticizing section 30 is reduced compared to when the low-precision mode or the high-speed mode is selected, by changing at least one of the set temperature of the heating section 120 and the set temperature of the cooling section 130. Thus, in the high-precision mode or the low-speed mode, the amount of the plasticized material fed from the plasticizing section 30 to the nozzle 61 can be reduced as compared with the low-precision mode or the high-speed mode. Therefore, in the third step when the high-precision mode is selected, for example, the ejection amount of plasticized material ejected from the nozzle 61 per unit time can be reduced in accordance with the moving speed of the nozzle 61, which was set to be slower, or the line width of the plasticized material, which was set to be thinner, than when the high-speed mode or the low-precision mode is selected.

Further, in the present embodiment, when the high-precision mode or the low-speed mode is selected, the allowable range of the pressure is narrowed compared with when the low-precision mode or the high-speed mode is selected. Accordingly, in the high-precision mode or the low-speed mode, compared to the low-precision mode or the high-speed mode, it is possible to further stabilize the amount of plasticized material ejected from the nozzle 61, and it is possible to increase the shaping precision of the three dimensional shaped object.

Also, in the present embodiment, when the high-precision mode or the low-speed mode is selected, compared to when the low-precision mode or the high-speed mode is selected, the screw rotation speed is smaller in at least one of a case when the outer shell region of the three dimensional shaped object is shaped or a case when the internal region is shaped. Accordingly, in the high-precision mode or the low-speed mode, it is possible to reduce the amount of plasticized material fed from plasticizing section 30 to the nozzle 61 when the outer shell region is shaped or when the internal region is shaped, compared to in the low-precision mode or in the high-speed mode. Therefore, in the third step when the high-precision mode is selected, the ejection amount of plasticized material ejected from the nozzle 61 per unit time can be reduced in accordance with the moving speed of the nozzle 61, which was set to be slower, or the line width of the plasticized material, which was set to be thinner, than when the high-speed mode or the low-precision mode is selected. Also, when the high-precision mode or the low-speed mode is selected, for example, the screw rotation speed may be decreased only in one of a case when the outer shell region is formed and a case when the internal region is formed. For example, in the high-precision mode or in the low-speed mode, by reducing the screw rotation speed only when shaping the outer shell region, it is possible to shorten the shaping time while accurately shaping a portion having a large influence on the appearance of the three dimensional shaped object.

In addition, in the present embodiment, when the high-precision mode or the low-speed mode is selected, the control sensitivity of the screw rotation speed with respect to the moving speed of the nozzle 61 is higher than when the low-precision mode or the high-speed mode is selected. Accordingly, in the high-precision mode or the low-speed mode, even when the moving speed of the nozzle 61 changes during shaping of the three dimensional shaped object, the ejection amount of plasticized material ejected from the nozzle 61 can be controlled with higher precision according to the change in the moving speed compared when the low-precision mode or the high-speed mode is selected. Therefore, for example, even when the moving speed changes in accordance with the direction change of the nozzle 61 during shaping, the line width or the like can be controlled with higher precision in the high-precision mode or the low-speed mode, and thus it is possible to shape the three dimensional shaped object with higher precision.

In the embodiment, the heating section 120 includes the first heating section 121 and the second heating section 122, which is closer to the communication hole 56 than is the first heating section 121 when viewed along the Z direction, and in the second step, the first heating section 121 and the second heating section 122 are individually controlled according to the shaping mode selected in the first step. Therefore, in the second step, the temperature of the region closer to the communication hole 56 and the temperature of the region farther from the communication hole 56 as viewed along the Z direction in the plasticizing section 30 can be individually and easily controlled in accordance with the shaping mode.

### B. Other Embodiments

(B1) In the above-described embodiment, the shaping mode may not include both of a mode related to the precision of the three dimensional shaped object and a mode related to the shaping time of the three dimensional shaped object, and may include only one of them. For example, the shaping modes may include only a mode related to the shaping time of the three dimensional shaped object, and the modes related to shaping time of the three dimensional shaped object may include a mode related to strength of the three dimensional shaped object, a mode related to surface roughness, a mode related to the filling rate, and the like. The reason why these modes correspond to the modes related to the shaping time is that the strength, the surface roughness, and the filling rate of the three dimensional shaped object are significantly related to the shaping time of the three dimensional shaped object. For example, in order to increase the strength, it is necessary to narrow the line width, narrow the lamination pitch, increase the filling rate, make the filling pattern complicated, and the like, and thus the shaping time becomes long. Similarly, when the surface roughness is made fine or when the filling rate is made large, the shaping time becomes long.

(B2) In the above-described embodiment, the control of the plasticizing section 30 according to the shaping mode is realized by generating the shaping data according to the shaping mode selected in the first step and controlling the plasticizing section 30 according to the generated shaping data in the second step. However, the shaping data may not be generated according to the shaping mode and, for example, control data including a control value and the like for controlling the plasticizing section 30 according to the shaping mode may be generated separately from the shaping data, and control of the plasticizing section 30 may be realized according to the shaping mode by controlling the plasticizing section 30 according to the control data in the second step.

(B3) In the above embodiment, when the high-precision mode or the low-speed mode is selected as the shaping mode, all of the screw rotation speed, the set temperature of the heating section 120, the set temperature of the cooling section 130, and the number of times of screw rotation control are different from those when the low-precision mode or the high-speed mode is selected. However, when the high-precision mode or the low-speed mode is selected, at least one of the above may be different from when the low-precision mode or the high-speed mode is selected.

(B4) In the above-described embodiment, when the high-precision mode or the low-speed mode is selected as the shaping mode, all of (1) decreasing the screw rotation speed, (2) decreasing the set temperature of the heating section 120, (3) decreasing the set temperature of the cooling section 130, and (4) increasing the number of times of screw rotation control are performed, compared to when the low-precision mode or the high-speed mode is selected. However, when the high-precision mode or the low-speed mode is selected, at least one of the above may be performed.

(B5) In the above embodiment, when the high-precision mode or the low-speed mode is selected as the shaping mode, the temperature gradient of the plasticizing section 30 is reduced compared to when the low-precision mode or the high-speed mode is selected. However, when the high-precision mode or the low-speed mode is selected, the temperature gradient of the plasticizing section 30 may not be reduced. For example, the temperature gradient of the plasticizing section 30 when the high-precision mode or the low-speed mode is selected may be the same as the temperature gradient of the plasticizing section 30 when the low-precision mode or the high-speed mode is selected.

(B6) In the above embodiment, in the second step, the screw rotation speed is controlled so that the detection value of the pressure sensor 140 falls within the predetermined allowable range. However, for example, the set temperature of the heating section 120 or the set temperature of the cooling section 130 may be controlled instead of the screw rotation speed so that the detection value of the pressure sensor 140 falls within the allowable range. Similarly, the set temperature of the heating section 120 and/or the set temperature of the cooling section 130 may be controlled together with the screw rotation speed so that the detected value falls within the allowable range. That is, at least one of the screw rotation speed, the set temperature of the heating section 120, or the set temperature of the cooling section 130 may be controlled so that the detected value falls within the allowable range.

(B7) In the above embodiment, when the high-precision mode or the low-speed mode is selected as the shaping mode, the allowable range of pressure of the plasticized material in the flow path 69 is narrowed compared to when the low-precision mode or the high-speed mode is selected. However, when the high-precision mode or the low-speed mode is selected as the shaping mode, the allowable range of the pressure may not be narrowed. For example, the allowable range of the pressure when the high-precision mode or the low-speed mode is selected may be the same as the allowable range of the pressure when the low-precision mode or the high-speed mode is selected. In addition, in the second step, it is not necessary to control the screw rotation speed, the set temperature of the heating section 120, or the set temperature of the cooling section 130 so that the detection value of the pressure sensor 140 falls within the allowable range. In this case, the three dimensional shaping device 100 may not include the pressure sensor 140.

(B8) In the above-described embodiment, when the high-precision mode or the low-speed mode is selected as the shaping mode, the screw rotation speed changes with high sensitivity with respect to the moving speed of the nozzle 61 compared to when the low-precision mode or the high-speed mode is selected. However, when the high-precision mode or the low-speed mode is selected as the shaping mode, the screw rotation speed may not change with high sensitivity with respect to the moving speed of the nozzle 61. For example, the screw rotation control sensitivity when the high-precision mode or the low-speed mode is selected and the screw rotation control sensitivity when the low-precision mode or the high-speed mode is selected may be the same.

(B9) In the above-described embodiment, the heating section 120 includes the first heating section 121 and the second heating section 122, and in the second step, the first heating section 121 and the second heating section 122 are individually controlled according to the shaping mode. However, for example, the heating section 120 may include three or more heating sections, and in the second step, each heating section may be individually controlled according to the shaping mode. The heating section 120 may include only one heating section. In addition, in the second step, it is not necessary to individually control each of the heating sections according to the shaping mode.

(B10) In the embodiment described above, the heating section 120 and the cooling section 130 are provided in the barrel 50 of the plasticizing section 30. However, a part or all of the heating section 120 and the cooling section 130 may be provided in the flat screw 40. In this case, for example, one of the first heating section 121 and the second heating section 122 may be provided in the flat screw 40, and the other may be provided in the barrel 50.

(B11) In the embodiment described above, the temperature gradient of the plasticizing section 30 is generated by controlling the first heating section 121, the second heating section 122, and the cooling section 130. However, the temperature gradient of the plasticizing section 30 may be generated by, for example, controlling only one of the heating section 120 or the cooling section 130. When the temperature gradient of the plasticizing section 30 is generated by controlling only the heating section 120, the cooling section 130 may not be provided in the plasticizing section 30.

(B12) In the above-described embodiment, the three dimensional shaping device 100 includes the suction and discharge section 75, but the three dimensional shaping device 100 may not include the suction and discharge section 75.

(B13) In the above embodiment, the ejection control section 70 controls ON/OFF of ejection of the plasticized material. In addition, the ejection control section 70 may be configured to be able to adjust the amount of the plasticized material flowing through the supply flow path 65 by changing the opening degree of the supply flow path 65, for example. In this case, for example, the ejection control section 70 changes the opening degree of the supply flow path 65 in accordance with the amount of the plasticized material fed from the plasticizing section 30 to the supply flow path 65.

(B14) In the above-described embodiment, the controller 101 sets the moving speed of the nozzle 61 to be slower than the normal speed when the nozzle 61 changes direction by 60° or more while discharging the plasticized material, when movement of the nozzle 61 and ejection of the plasticized material are stopped, or when movement of the nozzle 61 and ejection of the plasticized material are started or restarted. Alternatively or in addition to these, the controller 101 may, for example, set the moving speed of the nozzle 61 to be slower than the normal speed in a path having a path length shorter than a predetermined length. For example, a path for shaping a fine portion of a three dimensional shaped object or a plurality of continuous paths for shaping a curved portion correspond to such a path having a short path length. In these paths, by changing the screw rotation speed in conjunction with the moving speed of the nozzle 61, it is possible to increase precision in a fine portion or a curved portion of the three dimensional shaped object.

(B15) In the above embodiment, the controller 101 executes both the shaping data generation process and the three dimensional shaping process. However, the shaping data generation process and the three dimensional shaping process may be executed by different controllers. In this case, for example, the controller that executes the shaping data generation process is configured as an information processing apparatus, and the controller that executes the three dimensional shaping process is included in the three dimensional shaping device. The information processing apparatus includes a transmission section that transmits the shaping data to the three dimensional shaping device.

(B16) In the above-described embodiment, a pelletized ABS resin material is used as the raw material supplied to the material supply section 20. However, the three dimensional shaping device 100 can shape a three dimensional shaped object using various materials as main materials such as a material having thermoplasticity, a metal material, or a ceramic material. Here, “main material” means the central material for forming the shape of the three dimensional shaped object, and means a material occupying a content ratio of 50% by weight or more of the three dimensional shaped object. The above-described plasticized material includes a material obtained by melting the main material alone, and materials obtained by melting a portion of components that are contained together with the main material to form a paste.

When a material having thermoplasticity is used as a main material, the material is plasticized in the plasticizing section 30 to produce a plasticized material. “Plasticization” means that a material having thermoplasticity is melted by application of heat.

As the material having thermoplasticity, for example, the following thermoplastic resin materials can be used. Examples of thermoplastic resin materials

General purpose engineering plastics such as polypropylene resin (PP), polyethylene resin (PE), polyacetal resin (POM), polyvinyl chloride resin (PVC), polyamide resin (PA), acrylonitrile-butadiene-styrene resin (ABS), polylactic acid resin (PLA), polyphenylene sulfide resin (PPS), polyether ether ketone (PEEK), polycarbonate (PC), modified polyphenylene ether, polybutylene terephthalate, and polyethylene terephthalate and engineering plastics such as polysulfone, polyether sulfone, polyphenylene sulfide, polyarylate, polyimide, polyamide imide, polyetherimide, and polyether ether ketone.

The thermoplastic material may contain a pigment, metal, ceramic, or other additive such as wax, a flame retardant, an antioxidant, or a heat stabilizer. The thermoplastic material is plasticized and converted into a molten state in the plasticizing section 30 by rotation of the flat screw 40 and heating of the heater 58. The plasticized material generated by melting the material having thermoplasticity is ejected from the nozzle 61, and then cured by a decrease in temperature.

It is desirable that the thermoplastic material is heated to a temperature equal to or higher than its glass transition point and injected from the nozzle 61 in a completely melted state. For example, the glass transition point of ABS resin is about 120° C., and it is desirable that the ABS resin be at about 200° C. at the time of injection from the nozzle 61.

In the three dimensional shaping device 100, for example, the following metal materials may be used as the main material instead of the above-described materials having thermoplasticity. In this case, it is desirable that a powder material obtained by pulverizing the following metal material be mixed with a component that melts when the plasticized material is generated, and that the mixture be introduced into the plasticizing section 30 as a raw material.

### Examples of Metal Materials

A single metal selected from the group consisting of magnesium (Mg), iron (Fe), cobalt (Co), chromium (Cr), aluminum (Al), titanium (Ti), copper (Cu), and nickel (Ni), or an alloy containing one or more of these metals.

### Examples of Such Alloys

Maraging steel, stainless steel, cobalt-chromium-molybdenum, titanium alloy, nickel alloy, aluminum alloy, cobalt alloy, and cobalt-chromium alloy.

In the three dimensional shaping device 100, a ceramic material can be used as the main material instead of the above-described metal material. As the ceramic material, for example, oxide ceramics such as silicon dioxide, titanium dioxide, aluminum oxide, and zirconium oxide, non-oxide ceramics such as aluminum nitride, and the like can be used. When the above-described metal material or ceramic material is used as the main material, the plasticized material disposed on the stage 210 may be hardened by sintering with warm air or laser irradiation.

The powder material of a metal material or a ceramic material introduced as a raw material into the material supply section 20 may be a mixed material obtained by mixing a plurality of types of powder of a single metal, powder of an alloy, and/or powder of a ceramic material. In addition, the powder material of a metal material or a ceramic material may be coated with, for example, a thermoplastic resin exemplified above or another thermoplastic resin. In this case, the thermoplastic resin may be melted in the plasticizing section 30 to exhibit fluidity.

For example, a solvent like indicated below may be added to the powder material of a metal material and/or a ceramic material introduced as the raw material into the material supply section 20. The solvent can be used by itself or in combination of two or more kinds selected from the following.

### Examples of Solvents

Water; (poly) a alkylene glycol monoalkyl ether such as ethylene glycol monomethyl ether, ethylene glycol monoethyl ether, propylene glycol monomethyl ether, and propylene glycol monoethyl ether; an acetic ester such as ethyl acetate, n-propyl acetate, iso-propyl acetate, n-isobutyl acetate, and isobutyl acetate; an aromatic hydrocarbon such as benzene, toluene, and xylene; a ketone such as methyl ethyl ketone, acetone, methyl isobutyl ketone, ethyl-n-butyl ketone, diisopropyl ketone, and acetyl acetone; an alcohol such as ethanol, propanol and butanol; a tetra alkyl ammonium acetate; a sulfoxide solvent such as dimethyl sulfoxide and diethyl sulfoxide; a pyridine solvent such as pyridine, γ-picoline and 2,6-lutidine; a tetraalkylammonium acetate (for example, tetrabutylammonium acetate); an ionic liquid such as butylcarbitol acetate; and the like.

In addition, for example, a binder such as those below may be added to the powder material of the metal material and/or the ceramic material introduced as the raw material into the material supply section 20.

### Binder Examples

Acrylic resin, epoxy resin, silicone resin, cellulose resin, or other synthetic resin, or polylactic acid (PLA), polyamide (PA), polyphenylene sulfide (PPS), polyether ether ketone (PEEK), or other thermoplastic resin.

### C. Other Forms

The present disclosure is not limited to the embodiments described above, and can be realized in various forms without departing from the scope of the present disclosure. For example, the present disclosure can also be realized by the following forms. The technical features in the above-described embodiments corresponding to the technical features in each form described below can be appropriately replaced or combined in order to solve a part or all of the problems of the present disclosure or to achieve a part or all of the effects of the present disclosure. In addition, unless the technical features are described as essential in the present specification, the technical features can be appropriately deleted.

(1) According to a first aspect of the present disclosure, there is provided a method for producing a three dimensional shaped object. The method for producing a three dimensional shaped object includes a first step of receiving selection of a shaping mode of a three dimensional shaped object; a second step of plasticizing at least a portion of a material to form a plasticized material using a plasticizing section that includes a rotating flat screw and a barrel, the flat screw having a groove forming surface in which a groove is formed, the barrel having an opposing surface facing the groove forming surface and in which is formed a communication hole communicating with a nozzle; and a third step of ejecting the plasticized material from the nozzle toward a stage. In the second step, the plasticizing section is controlled in accordance with the shaping mode received in the first step.

According to this aspect, a user can shape a three dimensional shaped object having characteristics corresponding to a shaping mode by merely selecting the shaping mode, without the user himself repeating trial productions and finely adjusting the control data of the plasticizing section.

(2) In the aspect described above, the shaping mode may include at least one of a mode relating to shaping precision of the three dimensional shaped object and a mode relating to shaping time of the three dimensional shaped object. According to this aspect, the user can easily select a desired shaping mode from the modes prepared according to the shaping precision and the shaping time.

(3) In the above aspect, when a high-precision mode for shaping the three dimensional shaped object with high precision or a low-speed mode for shaping the three dimensional shaped object at low speed is selected as the shaping mode, then at least one of a number of rotations of the flat screw per unit time, a set temperature of a heating section that heats material supplied between the groove forming surface and the opposing surface, a set temperature of a cooling section for cooling the plasticizing section, or a number of times of rotation control of the flat screw per unit time

may differ compared to when a low-precision mode for shaping the three dimensional shaped object with low precision or a high-speed mode for shaping the three dimensional shaped object at high speed is selected as the shaping mode.

(4) In the above aspect, when the high-precision mode or the low-speed mode is selected as the shaping mode, at least one of (A) decreasing the number of rotations, (B) decreasing the set temperature of the heating section, (C) decreasing the set temperature of the cooling section, or (D) increasing the number of times of the rotation control may be performed compared to when the low-precision mode or the high-speed mode is selected.

(5) In the above aspect, when the high-precision mode or the low-speed mode is selected, at least one of the set temperature of the heating section or the set temperature of the cooling section differs from when the low-precision mode or the high-speed mode is selected, so that in the plasticizing section a temperature gradient, which rises from the outer edge of the opposing surface toward the communication hole as viewed along a direction in which the groove forming surface and the opposing surface face each other, may be reduced. According to this aspect, in the high-precision mode or the low-speed mode, the amount of the plasticized material fed from the plasticizing section to the nozzle can be reduced as compared with the low-precision mode or the high-speed mode. Therefore, for example, in the third step when the high-precision mode is selected, the ejection amount of plasticized material ejected from the nozzle per unit time can be reduced in accordance with the moving speed of the nozzle, which was set to be slower, or the line width of the plasticized material, which was set to be thinner, than when the high-speed mode or the low-precision mode is selected.

(6) In the above aspect, in the second step, at least one of the number of rotations, the set temperature of the heating section, or the set temperature of the cooling section may be controlled such that a detection value of the pressure sensor that detects pressure in the flow path through which the plasticized material flows falls within a predetermined allowable range and, when the high-precision mode or the low-speed mode is selected, the allowable range may be narrowed compared to when the low-precision mode or the high-speed mode is selected. According to this aspect, in the high-precision mode or the low-speed mode, compared to the low-precision mode or the high-speed mode, it is possible to further stabilize the amount of plasticized material ejected from the nozzle, and it is possible to increase the shaping precision of the three dimensional shaped object.

(7) In the above aspect, when the high-precision mode or the low-speed mode is selected, the number of rotations may be smaller than when the low-precision mode or the high-speed mode is selected, in at least one of a case in which an outer shell region of the three dimensional shaped object is formed or a case in which an internal region that is inside the outer shell region of the three dimensional shaped object is formed. According to this aspect, in the high-precision mode or the low-speed mode, it is possible to reduce the amount of plasticized material fed from plasticizing section to the nozzle when the outer shell region is shaped or when the internal region is shaped, compared to in the low-precision mode or in the high-speed mode. Therefore, in the third step when the high-precision mode is selected, the ejection amount of plasticized material ejected from the nozzle per unit time can be reduced in accordance with the moving speed of the nozzle, which was set to be slower, or the line width of the plasticized material, which was set to be thinner, than when the high-speed mode or the low-precision mode is selected.

(8) In the above aspect, the number of rotations in the second step may be changed in conjunction with a relative moving speed of the nozzle in the third step, and when the high-precision mode or the low-speed mode is selected, control sensitivity of the number of rotations with respect to the moving speed may be higher than when the low-precision mode or the high-speed mode is selected. According to this aspect, in the high-precision mode or the low-speed mode, even when the moving speed of the nozzle changes during shaping of the three dimensional shaped object, the ejection amount of plasticized material ejected from the nozzle can be controlled with higher precision according to the change in the moving speed compared when the low-precision mode or the high-speed mode is selected. Therefore, in the high-precision mode and the low-speed mode, it is possible to shape the three dimensional shaped object with higher precision.

(9) In the aspect described above, the heating section may include a first heating section and a second heating section, which is closer to the communication hole than the first heating section as viewed along a direction in which the groove forming surface and the opposing surface face each other, and in the second step, the first heating section and the second heating section may be individually controlled according to the shaping mode selected in the first step. According to this aspect, in the second step, the temperature of the region closer to the communication hole and the temperature of the region farther from the communication hole as viewed along the direction in which the groove forming surface and the opposing surface face each other in the plasticizing section 30 can be individually and easily controlled in accordance with the shaping mode.

(10) According to a second aspect of the present disclosure, a three dimensional shaping device is provided. The three dimensional shaping device includes a nozzle configured to eject plasticized material toward a stage; a plasticizing section configured to plasticize at least a portion of a material to form a plasticized material, the plasticizing section including a rotating flat screw and a barrel, the flat screw having a groove forming surface in which a groove is formed, the barrel having an opposing surface facing the groove forming surface and in which is formed a communication hole communicating with the nozzle; and a controller configured to control the plasticizing section in accordance with a selected shaping mode to shape a three dimensional shaped object.

What is claimed is:

1. A method for producing a three dimensional shaped object, the method comprising:
a first step of receiving selection of a shaping mode of a three dimensional shaped object;
a second step of using a plasticizing section to plasticize at least a portion of a material to form a plasticized material, the plasticizing section including a rotating flat screw and a barrel, the flat screw having a groove forming surface in which a groove is formed, the barrel having an opposing surface facing the groove forming surface and in which is formed a communication hole communicating with a nozzle; and
a third step of ejecting the plasticized material from the nozzle toward a stage,
wherein in the second step, the plasticizing section is controlled in accordance with the shaping mode received in the first step.

2. The method for producing a three dimensional shaped object according to claim 1, wherein
the shaping mode includes at least one of a mode relating to shaping precision of the three dimensional shaped object and a mode relating to shaping time of the three dimensional shaped object.

3. The method for producing a three dimensional shaped object according to claim 2, wherein
when a high-precision mode for shaping the three dimensional shaped object with high precision or a low-speed mode for shaping the three dimensional shaped object at low speed is selected as the shaping mode, then at least one of a number of rotations of the flat screw per unit time, a set temperature of a heating section that heats material supplied between the groove forming surface and the opposing surface, a set temperature of a cooling section for cooling the plasticizing section, or a number of times of rotation control of the flat screw per unit time
differs compared to when a low-precision mode for shaping the three dimensional shaped object with low precision or a high-speed mode for shaping the three dimensional shaped object at high speed is selected as the shaping mode.

4. The method for producing a three dimensional shaped object according to claim 3, wherein
when the high-precision mode or the low-speed mode is selected as the shaping mode, at least one of (1) decreasing the number of rotations, (2) decreasing the set temperature of the heating section, (3) decreasing the set temperature of the cooling section, or (4) increasing the number of times of the rotation control is performed compared to when the low-precision mode or the high-speed mode is selected.

5. The method for producing a three dimensional shaped object according to claim 3, wherein
when the high-precision mode or the low-speed mode is selected, at least one of the set temperature of the heating section or the set temperature of the cooling section differs from when the low-precision mode or the high-speed mode is selected, so that in the plasticizing section a temperature gradient, which rises from the outer edge of the opposing surface toward the communication hole as viewed along a direction in which the groove forming surface and the opposing surface face each other, is reduced.

6. The method for producing a three dimensional shaped object according to claim 3, wherein
in the second step, at least one of the number of rotations, the set temperature of the heating section, or the set temperature of the cooling section is controlled so that a detection value of a pressure sensor that detects pressure in a flow path through which the plasticized material flows falls within a predetermined allowable range and
when the high-precision mode or the low-speed mode is selected, the allowable range is narrowed compared with when the low-precision mode or the high-speed mode is selected.

7. The method for producing a three dimensional shaped object according to claim 3, wherein
when the high-precision mode or the low-speed mode is selected, the number of rotations is smaller than when the low-precision mode or the high-speed mode is selected, in at least one of a case in which an outer shell region of the three dimensional shaped object is formed or a case in which an internal region that is inside the outer shell region of the three dimensional shaped object is formed.

8. The method for producing a three dimensional shaped object according to claim 3, wherein
in the third step, the nozzle is moved relative to the stage,
the number of rotations in the second step is changed in accordance with the relative moving speed of the nozzle in the third step, and
when the high-precision mode or the low-speed mode is selected, the control sensitivity of the number of rotations with respect to the moving speed is higher compared with when the low-precision mode or the high-speed mode is selected.

9. The method for producing a three dimensional shaped object according to claim 3, wherein
the heating section includes a first heating section and a second heating section that is closer to the communication hole than is the first heating section as viewed along a direction in which the groove forming surface and the opposing surface face each other and
in the second step, the first heating section and the second heating section are individually controlled in accordance with the shaping mode selected in the first step.

10. A three dimensional shaping device comprising:
a nozzle configured to eject plasticized material toward a stage;
a plasticizing section configured to plasticize at least a portion of a material to form a plasticized material, the plasticizing section including a rotating flat screw and a barrel, the flat screw having a groove forming surface in which a groove is formed, the barrel having an opposing surface facing the groove forming surface and in which is formed a communication hole communicating with the nozzle; and
a controller configured to control the plasticizing section in accordance with a selected shaping mode to shape a three dimensional shaped object.
